(19) United States
(12) Patent Application Publication
(10) Pub. No.: US 2025/0106812 A1
(43) Pub. Date: Mar. 27, 2025

(54) METHODS FOR HANDLING MOBILITY OF A WIRELESS DEVICE AND RELATED NETWORK NODES

(71) Applicant: Sony Group Corporation, Tokyo (JP)

(72) Inventors: Lars NORD, Lund (SE); Torgny PALENIUS, Barsebäck (SE); Svante ALNÅS, Lund (SE)

(21) Appl. No.: 18/727,321

(22) PCT Filed: Jan. 18, 2023
(86) PCT No.: PCT/EP2023/051152

§ 371 Date: Jul. 8, 2024

(30) Foreign Application Priority Data
Jan. 28, 2022 (SE) 2250083-9

(51) Int. Cl. H04W 64/00; H04W 8/14; H04W 8/26; H04W 68/02

(52) U.S. Cl. CPC H04W 64/006; H04W 8/14; H04W 8/26; H04W 68/02

(57) ABSTRACT

A method is disclosed, performed by a first radio network node, for handling mobility of a wireless device connected to a core network node. The first radio network node is outside a radio access network notification area (RNA) associated with the wireless device. The method comprises receiving, from the wireless device, one or more message(s) indicating that the WD has moved outside the RNA. The at least one message comprises a temporary identifier assigned to the WD. The method comprises sending to the core network node, upon failing to retrieve a User Equipment (UE) context for the WD directly from the RNA, a message requesting assistance in retrieving the UE context of the WD, wherein the message comprises a temporary identifier assigned to the WD.

The present disclosure pertains to the field of wireless communications. The present disclosure relates to methods for handling mobility of a wireless device connected to a core network node, a related first radio network node, a related core network node, and a related second radio network node.

### BACKGROUND

In the 3rd Generation Partnership Project (3GPP) it has been discussed that for new User Equipment (UE) category referred to Reduced Capability (RedCap) UE, it would be useful to allow such UEs to sleep for longer periods, also when the UE is in Radio Resource Control (RRC) Inactive mode. In Rel-16, for 5G Cellular Internet of Things (CIoT), it has been discussed how to handle long Extended Discontinuous Reception (eDRX), such as eDRX longer than 10.24 s. In 5G two states have been defined that a UE can enter to conserve energy: RRC-Idle state and RRC-Inactive state. Both states allow the UE to minimize the required UE activities on a radio interface of the UE. The UE behaviour in these two states is similar. However, when the UE resumes user plane traffic, the RRC-Inactive state can provide a more efficient transition between RRC-Inactive state and RRC-Connected State compared to the transition between RRC-Idle state and RRC-Connected state. The network behaviour however is fundamentally different. In Idle state the Core Network (CN) is responsible of UE management including paging the UE, but in RRC-Inactive state the Radio Access Network (RAN) is responsible of UE management including paging the UE, which is also known as RAN based paging.

In 3GPP Rel-16, it was decided that CIoT UEs only are allowed to use eDRX shorter than 10.24s when in RRC-Inactive state. One reason being that CIoT UEs are not expected to send user data over the User plane, instead use the Data over NAS feature (DoNAS). Thereby the CIoT UE can transmit data while in Idle state.

However, RedCap UEs specified in Rel-17 use the User plane for user data and not DoNAS. Therefore, the discussion on combining RRC-Inactive with eDRX >10.24 s become of interest again in 3GPP.

The question is how to handle DownLink (DL) data that would trigger the paging. As specified today for RRC-Inactive, the UE is still in CN-Connected state which means that the data path between a User Plane Function (UPF) and the RAN is still active and all DL data and/or signaling will be forwarded directly to the RAN, as from a CN perspective the UE is ready to receive any DL information directly or with small delay (never more than 10.24 s but typically around 1.28 s). When 3GPP now aims to increase the allowed eDRX in RRC-Inactive to large values of 1-3 hours, the handling of the DL data becomes problematic.

While the UE is in eDRX, the UE may move between radio access network notification areas (RNAs) that have no connectivity with each other. During the eDRX time period DL data may arrive and be buffered at a previous radio network node that holds a UE Context of the UE. When the UE leaves the eDRX cycle, such as enters RRC Connected state it may be under coverage and be served by a radio network node that has no connectivity to the previous radio network node. Thus, the DL data buffered at the previous radio network node can't be forwarded to the UE and may thus be lost, such as may never reach the UE.

### SUMMARY

Accordingly, there is a need for devices and methods for handling mobility of a wireless device (WD), which may mitigate, alleviate or address the shortcomings existing and may provide a solution which facilitates a communication with the WD being resumed and reduces the likelihood of DL data for the WD being lost due to mobility of the WD.

A method is disclosed, performed by a first radio network node, for handling mobility of a wireless device connected to a core network node. The first radio network node is outside a radio access network notification area (RNA) associated with the wireless device. The method comprises receiving, from the wireless device, one or more message(s) indicating that the WD has moved outside the RNA. The at least one message comprises a temporary identifier assigned to the WD. The method comprises sending to the core network node, upon failing to retrieve a User Equipment (UE) context for the WD directly from the RNA, such as from a second radio network node in the RNA, a message requesting assistance in retrieving the UE context of the WD, wherein the message comprises a temporary identifier assigned to the WD.

Further, a first radio network node is provided, the first radio network node comprising memory circuitry, processor circuitry, and a wireless interface, wherein the first radio network node is configured to perform any of the methods disclosed herein and relating to the first radio network node.

It is an advantage of the present disclosure that a loss of DL data for a WD can be prevented during mobility of the WD between RNAs. The second radio network node can request assistance from the core network node in retrieving a UE context based on a temporary identifier associated with the WD, such as based on a RAN temporary identifier and/or a CN temporary identifier. Using the RAN temporary identifier associated with the WD in the RNA when requesting assistance from the core network node further has the benefits that a UE context of the WD may be retrieved from the second radio network node. Thereby, the WD can resume an ongoing RRC Connection from the RNA with the second radio network node outside the RNA. This can reduce the signaling required between the WD and the network to resume the communication with the WD. A further advantage, If the first radio network node receives the CN temporary identifier, such as the 5G-S-TMSI from the WD then the first radio network node can send the assistance request to the core network node associated with the WD and thereby simplify for the core network node to retrieve the UE context and/or the DL data for the WD from the first radio network node. This enables the WD to be successful in the Mobility Update (which may also be referred to as an RNA Update due to mobility). Furthermore, the core network node may aid the first radio network node outside the first RNA with retrieval of the UE context and/or the DL data for the WD from the second radio network node, even though there may be no direct connectivity between the first radio network node and the second radio network node.

A method is disclosed, performed by a core network node, for handling mobility of a wireless device. The wireless device is connected to the core network node. The method comprises receiving, from a first radio network node outside an RNA associated with the wireless device, a message requesting assistance in retrieving a UE context of the WD. The message comprises a temporary identifier assigned to the WD. The method comprises retrieving, from a second radio network node in the RNA, the UE context of the WD based on the temporary identifier assigned to the WD. The method comprises transmitting the retrieved UE context of the WD to the first radio network node.

Further, a core network node is provided, the core network node comprising memory circuitry, processor circuitry, and a wireless interface, wherein the core network node is configured to perform any of the methods disclosed herein and relating to the core network node.

It is an advantage of the present disclosure that a loss of DL data for a WD can be prevented during mobility of the WD between RNAs. The core network node may aid the radio network node outside the first RNA with retrieval of DL data for the WD from a second radio network node, based on the temporary identifier associated with the WD, even though there may be no direct connectivity between the first radio network node and the second radio network node. The risk of DL data being lost due to mobility of the WD using a long eDRX can thus be reduced. Furthermore, when the temporary identifier is the RAN temporary identifier associated with the WD in the RNA the core network node can assist the first radio network node in retrieving a UE context of the WD from the second radio network node. Thereby, the WD can resume an ongoing RRC Connection from the RNA with the second radio network node outside the RNA. This can reduce the signaling required between the WD and the network and the time to resume the communication with the WD. Furthermore, the core network may aid in forwarding of DL data even if the first radio network node is unaware of such buffered DL data in the second radio network node.

A method is disclosed, performed by a second radio network node, for handling mobility of a wireless device. The wireless device is connected to a core network node. The second radio network node serves an RNA associated with the wireless device. The method comprises sending to the core network node, upon failing to page the WD in the RNA, a release request message requesting the core network node to release a UE context for the wireless device, wherein the release request message comprises an indication that the second radio network node has DL data to be transmitted to the wireless device.

Further, a second radio network node is provided, the second radio network node comprising memory circuitry, processor circuitry, and a wireless interface, wherein the second radio network node is configured to perform any of the methods disclosed herein and relating to the second radio network node.

It is an advantage of the present disclosure that a loss of DL data for a WD can be prevented during mobility of the WD between RNAs. The second radio network node can inform the core network node that paging of the WD in the RNA has failed and that DL data destined for the WD still remains, such as is pending, in the second radio network node. Informing the core network node about the remaining DL data enables the core network to initiate paging, such as core network paging, in a wider geographical area than the RNA, such as in a Registration Area (RA) of the WD. It can also enable the core network node to retrieve the pending DL data from the second radio network node and forward it to the first radio network node. Furthermore, when the temporary identifier is the RAN temporary identifier associated with the WD in the RNA the core network node is enabled to assist the first radio network node in retrieving a UE context of the WD from the second radio network node. Thereby, the WD can resume an ongoing RRC Connection from the RNA with the second radio network node outside the RNA. This can reduce the signaling required between the WD and the network and the time to resume the communication with the WD.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node and an example wireless device according to this disclosure,

FIG. 2 is a signaling diagram illustrating an example message exchange according to this disclosure when a retrieval of a UE context for a WD within a radio access network fails,

FIG. 3 is a flow-chart illustrating an example method, performed in a first radio network node of a wireless communication system, for handling mobility of a wireless device to resume communication according to this disclosure,

FIG. 4 is a flow-chart illustrating an example method, performed in a core network node of a wireless communication system, for handling mobility of a wireless device to resume communication according to this disclosure,

FIG. 5 is a flow-chart illustrating an example method, performed in a second radio network node of a wireless communication system, for handling mobility of a wireless device to resume communication according to this disclosure,

FIG. 6 is a block diagram illustrating an example first radio network node according to this disclosure,

FIG. 7 is a block diagram illustrating an example core network node according to this disclosure, and

FIG. 8 is a block diagram illustrating an example second radio network node according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

A connected mode may be referred to as an operation mode wherein a data transmission can be communicated, for example, between the wireless device and a network node or between the wireless device and another wireless device. A connected mode may be referred to as an operation state wherein a radio transmitter and/or a radio receiver is activated for such communication. A connected mode may be referred to as an operation state wherein the wireless device is synchronized time-wise and/or frequency-wise for example by a determined timing advance parameter for the communication. In certain communication systems, a connected mode may be referred to as a radio resource control (RRC) state. In various examples, an active state may be a RRC connected state and/or an RRC active state. A connected mode may be an active period within another RRC state.

The dormant mode can be a mode where the UE has no active connection with the network node. A dormant mode may be seen as an inactive mode of the wireless device. A dormant mode may be seen as a mode where the wireless device is unsynchronized with a timing of a network. In one or many examples the wireless device may in a dormant mode not have a valid timing advance information with respect to the network. A dormant mode may be seen as a mode where the wireless device is unable to receive dedicated signaling. A dormant mode may be seen as a mode where closed loop power control is inactivated or suspended. Dormant mode may comprise an RRC idle state and/or RRC inactive state. For example, the wireless device may be in dormant mode when the connection with the network node has been released and/or suspended, or when a transceiver of the wireless device is turned off.

The figures are schematic and simplified for clarity, and they merely show details which aid understanding the disclosure, while other details have been left out. Throughout, the same reference numerals are used for identical or corresponding parts.

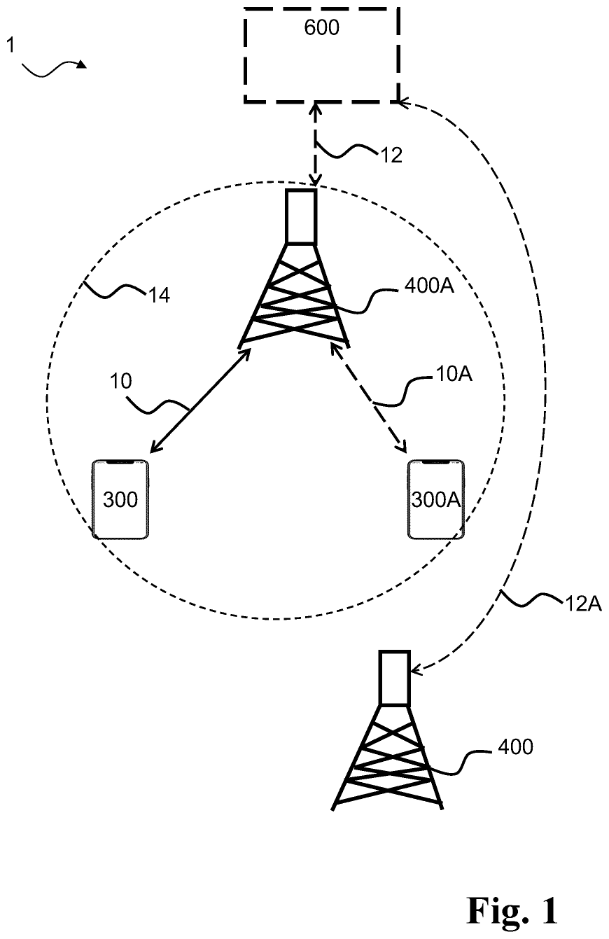

FIG. 1 is a diagram illustrating an example wireless communication system 1 comprising an example first network node 400 and an example wireless device 300 according to this disclosure.

As discussed in detail herein, the present disclosure relates to a wireless communication system 1 comprising a cellular system, for example, a 3GPP wireless communication system. The wireless communication system 1 comprises a wireless device 300, a first radio network node 400, a second radio network node 400A, and/or one or more core network nodes 600.

A radio network node disclosed herein refers to a radio access network node operating in the radio access network, such as a base station, such as an evolved Node B, eNB, gNB in a 5G system. In one or more examples, the RAN node is a functional unit which may be distributed in several physical units.

A core network, CN, node disclosed herein refers to a network node operating in the core network, such as in the Evolved Packet Core Network, EPC, and/or a 5G Core Network, 5GC. Examples of CN nodes in EPC and 5GC include but are not limited to a Mobility Management Entity (MME), an Access and Mobility Management Function (AMF), a Session Management Function (SMF) and or a User Plane Function (UPF). In one or more examples, the CN node is a functional unit which may be distributed in several physical units.

The wireless communication system 1 described herein may comprise one or more wireless devices 300, 300A, and/or one or more radio network nodes 400, 400A such as one or more of: a base station, an eNB, a gNB and/or an access point.

A wireless device may refer to a mobile device and/or a user equipment, UE.

The wireless device 300, 300A may be configured to communicate with the first radio network node and/or the second radio network node 400 via a wireless link (or radio access link) 10, 10A.

The first radio network node 400 may be configured to communicate with the CN node 600 via a wired or wireless link 12. The second radio network node 400A may be configured to communicate with the CN node 600 via a wired or wireless link 12A.

The second radio network node 400A may be an anchor node in the RNA 14, such as a radio network node that holds a UE context of the WD. The second radio network node may thus be the last radio network node that has been serving the WD 300 in the RNA 14 associated with the WD. The RNA 14 may comprise one or more radio network nodes. When the WD is in the RRC-Inactive state, air interface resources with the WD are released but the WD's context, such as the UE context, remains on the RAN anchor node, such as the last serving radio network node, in this case the second radio network node 400A. Upon the last serving radio network node receives DL data from a User Plane function (UPF) in the core network, or signaling from the core network node, such as from the AMF, the last serving radio network node may page the WD and may trigger paging in one or more cells corresponding to the RNA 14. This may include sending the paging to neighbor radio network nodes, which belong to the RNA 14, across for example an interface between two radio network nodes, such as an Xn interface.

During the RRC-Inactive state, the WD 300 may perform mobility, such as may move geographically, and may thus no longer be available in the RNA associated with the WD when the paging is sent in the RNA 14. In one or more example methods, the WD may have moved from the RNA 14 towards the first radio network node 400 and may no longer hear signaling in first RNA 14. Upon the WD 300 detecting that it has moved to a cell which is not part of the current RNA assigned to the WD, such as to a cell served by the first radio network node 400, the WD 300 may perform an RNA update procedure. Since the second radio network node 400A may no longer be able to reach the WD 300, such as may not receive a response to the paging, the DL data received by the second radio network node 400A may be lost in the second radio network node 400A. Lost herein means that it does not reach the WD 300. When the WD 300 applies long eDRX, the WD 300 may remain in RRC-Inactive state for longer times and may thus move further during the RRC-Inactive state than a WD applying a shorter eDRX would. A long eDRX may herein be an eDRX being longer than 10.24 s, such as up to one or more hours, a short eDRX may herein be an eDRX being equal to or shorter than 10.24 s. The eDRX enables WDs to reduce power consumption by extending the period of time they remain asleep, such as the period of time in which the WD is in a dormant mode and is unable to receive dedicated signaling. eDRX referred to herein corresponds to eDRX as specified in 3GPP TS 23.501, v. 17.3.0.

The current disclosure addresses aspects related to data forwarding between two radio network nodes when mobility of the WD has resulted in the WD moving to a radio network node that does not have an Xn interface available with the last serving radio network node of the WD in combination with the WD using long eDRX and a paging time window (PTW). The PTW may have a predefined first duration, such as in the range of 1-30 s, such as 1-20 s. During the PTW the WD may monitor paging occasions. The PTW may be periodic, such that the PTW repeats after a predetermined second time duration. The predetermined second time duration may be the eDRX duration. A long eDRX may herein be seen as an eDRX being longer than 10.24 s. The PTW may be a PTW as specified in 3GPP TS 23.501 ver. 17.3.0, clause 5.31.7.2. The PTW allows the CN or the first radio network node to repeat paging in greater and greater geographical areas within one, such as a single, eDRX cycle. The greater area, such as a wider area, may be a Registration Area (RA) for the CN and the RNA for the first radio network node. The RA may be an area that the CN normally pages the WD in. The RA may comprise a plurality of Tracking Areas (TAs) associated with the WD. When the WD wakes up to monitor a paging occasion (PO) with a configured PTW, the WD may monitor a sequence of POs, such as a sequence comprising a plurality of POs, such as 4 POs in sequence, before going back to sleep, such as entering dormant mode, and thus not being reachable by the network.

According to an example scenario of the current disclosure, the WD may have been released to RRC-Inactive state by its RAN anchor node, which in this disclosure is corresponds to the second radio network node. The WD may thus be in the RRC-Inactive state. Upon releasing the WD to RRC-Inactive state, the anchor node may configure the WD with a RAN temporary identifier and an RNA configuration. The RAN temporary identifier may be an Inactive Radio Network Temporary Identifier (I-RNTI). The WD may be configured to use long eDRX, such as an eDRX being longer than 10.24 s. The RAN anchor node of the RNA may receive DL data, which may also be referred to as Mobile Terminated (MT) data, destined for the WD. The RAN anchor node may buffer the data until the WD starts to monitor POs, such as according to the eDRX scheme of the WD. The WD may monitor POs during its paging time window. During the RRC-Inactive state the WD may move outside the RNA of the RAN anchor node. Prior to the first PO of the PTW the WD may start searching for a target radio network node to resynchronise with. The WD may detect that it has moved outside the RNA configured for the WD, for example by detecting that the target radio network node it tries to resynchronise with is outside the configured RNA (as the target radio network node is not within the RNA configuration), and may perform an RNA update (RNAU) due to mobility in accordance with 3GPP TS 38.300 v16.7.0, clause 9.2.2.1, with the radio network node outside the RNA. The WD may perform the RNA update using the RAN temporary identifier, such as the I-RNTI, configured for the WD in the RNA. The target radio network node, such as the first radio network node 400 according to this disclosure, may try to retrieve the UE context for the WD based on the RAN temporary identifier and/or any buffered DL data from the RAN anchor node, but may fail due to no Xn interface being available between the RAN anchor node and the target radio network node. It may therefore not be possible for the target radio network node to resolve the RAN temporary identifier, such as the I-RNTI. Around the same time the RAN anchor node may start to page the WD in the first RNA. The RAN anchor node may fail to page the WD, for example due to the WD having moved out of the RNA.

According to 3GPP TS 23.501 ver. 17.3.0 clause 5.3.3.2.5, when RAN based paging fails after trying to reach the WD in the RNA, the RAN, such as the RNA anchor node, shall initiate an Access Network (AN) release. Thereby, the DL data may be lost. The paging failure may be due to a first radio network node (such as an anchor node, such as a radio network node that holds a UE context of the WD) receiving DL data prior to the eDRX cycle expires or prior to the next PTW and the WD having moved outside the RNA before the WD wakes up from the eDRX cycle and detects that it is outside the RNA and can inform the network of the new location by performing an RNA update procedure (such as according to 3GPP TS 38.300 v16.7.0, clause 9.2.2.1). According to 3GPP TS 38.331 v. 16.7.0, when a target RAN node, such as a radio network node outside the RNA, fails to retrieve the UE context from the RNA anchor node, the new RAN node shall REJECT the RNA update received from the with an RRC Reject. This may trigger the WD to discard any RNA configuration received earlier and move to RRC-Idle and/or Connection Management (CM) Idle (core network Idle). All together this may result in that the DL data is lost and extra signalling overhead may be needed to re-establish the WD connection to both the CN and the RAN at a later stage.

According to the current disclosure the radio network node outside the RNA may request and/or receive assistance from the core network node, such as from the AMF, in resolving the RAN temporary identifier to retrieve the UE context for the WD and in forwarding any pending DL data from the RAN anchor node to new RAN node outside the RNA via the CN.

The RAN anchor node may notify the CN node, such as may send a notification message to the CN node, that the WD does not respond to paging in the RNA. In one or more example methods, the RAN anchor node may notify the CN node that it has buffered DL data for the WD. In one or more example methods, the notification may comprise the RAN temporary identifier, such as the I-RNTI, associated with the WD in the RNA. In one or more example methods, the notification may comprise an indication that there is pending DL data in the RAN anchor node, such as pending MT data. In one or more example methods, the notification message is a release request message, such as a UE release request message. The release request message may comprise the RAN temporary identifier and/or the indication that there is pending DL data in the RAN anchor node, such as pending MT data. In one or more example methods, the RAN temporary identifier is indicative of there being pending DL data in the RAN anchor node. In other words, sending the RAN temporary identifier in the notification message, such as in the UE Context Release Request, may indicate to the CN node that there is pending DL data for a WD configured with the RAN temporary identifier. in one or more example methods the indication that there is pending DL data in the RAN anchor node may be a flag, such as a Pending MT data flag, or a pending DL data flag. In one or more example methods, the RAN anchor node may send the pending DL data to the CN node in association with the notification message, such as comprised in the notification message or comprised in an additional message sent to the CN node, such as the AMF, together with the notification message.

The RAN anchor node may notify the CN node, such as the AMF, before the expiration of a PTW of the WD. The RAN anchor node may keep the data until the RAN anchor node receives a context release command message, such as a UE Context Release Command message, from the CN node. The CN node may delay the context release command message to allow time to perform CN paging and/or to wait for another radio network node to check, such as resolve, the RAN temporary identifier as part of an RNA Update from the WD.

The target radio network node, which may be outside the RNA of the WD, may check with the CN node, such as with the AMF, whether it has or can retrieve any records of a WD with the RAN temporary identifier, such as with the I-RNTI. Having records may herein mean having information about the WD, such as having a UE context and/or DL data for the WD. Upon the CN node having records of the WD the RAN temporary identifier, the radio network node outside the RNA may resolve the RAN temporary identifier. Upon resolving the RAN temporary identifier, the radio network node outside the RNA may acknowledge the resume request from the WD. Upon not being able to resolve the RAN temporary identifier, such as due to the CN node not having or not able to retrieve any records of the WD, the radio network node outside the RNA may reject the resume request from the WD.

If the CN node, such as the AMF, has a record of the RAN temporary identifier then the CN node informs both the target radio network node and the RAN anchor node and initiates UE context and DL data transfer between RAN anchor node and the target radio network node.

In one or more example methods, the RNA update may comprise a CN temporary identifier, such as a 5G-S-TMSI. The CN temporary identifier, such as the 5G-S-TMSI may be used in the assistance request from the target radio network node to the CN node, such as to the AMF, (also to the specific Cn node, such as the specific AMF, that has the UE CN context). The CN node may, based on the CN identifier comprised in the assistance request, identify which the RAN anchor node is for the WD and may request the UE AS context from the RAN anchor node.

The WD performing the RNA update and/or the target radio network node checking with the CN node may occur independently from the RAN anchor node informing the CN node of the paging failure. Hence, the WD performing the RNA update and/or the target radio network node checking with the CN node may occur prior to, simultaneously with and/or after the RAN anchor node informing the CN node of the paging failure. If the “check” by the target radio network node is received by the CN node, the CN node does not have to wait for the message from the RAN anchor node of the RNA. The CN node may try to resolve the RNAU based on the RAN temporary identifier and may check with the RAN anchor node whether there is pending DL data at the RAN anchor node.

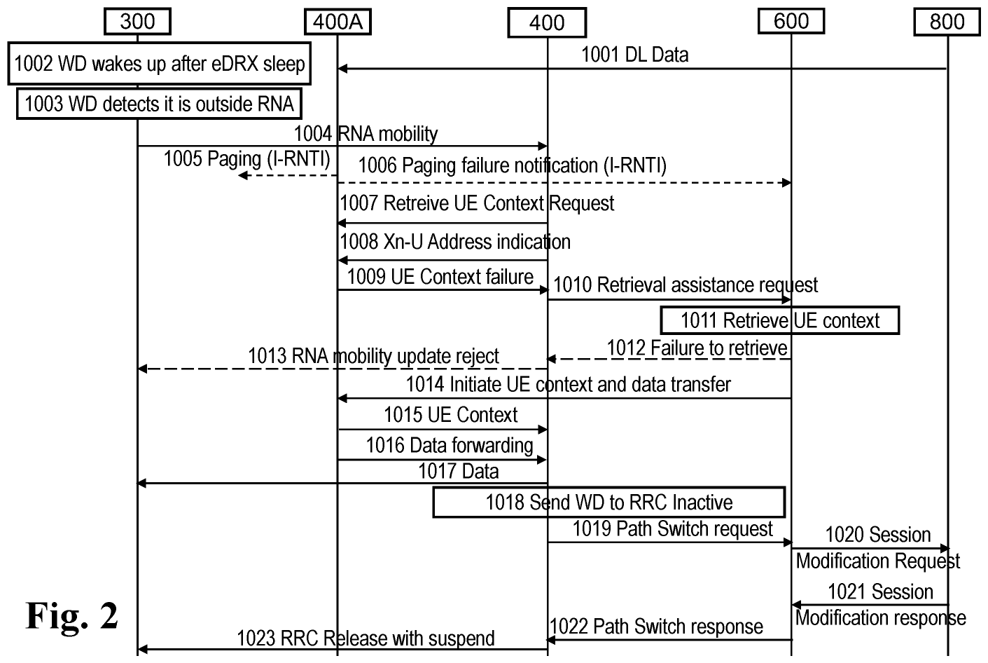

FIG. 2 is a signaling diagram illustrating an example message exchange between a first radio network node 400 (such as the target radio network node disclosed herein), the second radio network node 400A (such as the RAN anchor node disclosed herein), the core network node 600, a UPF 800 and the WD 300 for handling mobility of the WD 300 according to one or more example methods disclosed herein. The WD 300 may be configured to use eDRX with long eDRX cycle and may be configured with a PTW.

The second radio network node 400A may receive DL data 1001 from the core network node 600, such as via the UPF 800. The second radio network node 400A may be aware of, such as may have information indicating, that the WD 300 is using eDRX with long eDRX cycle and that the WD 300 is configured with the PTW. In one or more example methods, the second radio network node 400A may have received the information indicating that the WD 300 is using eDRX with long eDRX cycle from the CN node 600, in case the WD 300 has been configured by the CN 600 during a registration procedure. In one or more example methods, the second radio network node 400A may have the information indicating that the WD 300 is using eDRX with long eDRX cycle because it has itself configured the WD with the eDRX.

In one or more example methods, the WD 300 may wake up from the eDRX cycle 1002, such as from an RRC Inactive State. In case the WD 300 has moved during the eDRX cycle, the WD 300 may detect 1003 that it is outside the RNA. Upon the WD 300 detecting 1003 that it is outside the RNA, the WD 300 may initiate an RNA mobility update (RNAU) with the first radio network node 400 outside the first RNA. The WD 300 may initiate the RNAU by sending an RNA mobility update message 1004 to the first radio network node 400. The RNA mobility update message 1004 may comprise the RAN temporary identifier associated with the WD 300 in the RNA and/or a core network temporary identifier. The second radio network node 400A receiving DL data 1001 and paging 1005 the WD 300 may occur independently from the WD 300 waking up 1002 from the eDRX cycle. Hence, the WD 300 waking up from the eDRX cycle may occur prior to, simultaneously with and/or after to the first radio network node 400 receiving DL data and paging the WD 300. The RAN mobility update message may be a resume request message, such as a msg 3 in Random Access Channel (RACH) procedure.

The second radio network node 400A may page the WD 300, such as may send a paging message 1005, within the first RNA. The paging message may be broadcasted in the first RNA and may not reach the WD 300, for example due to the WD 300 no longer being in the RNA, as indicated by the arrow in FIG. 2A not reaching all the way to the WD 300. The second network node 400A may page the WD 300 using a RAN temporary identifier, such as an I-RNTI, assigned to the WD 300 in the first RNA.

Upon the paging not succeeding, such as upon the second network node 400A not receiving a paging response from the WD 300, the second network node 400A may send a paging failure notification message 1006 to the CN node 600 to inform the core network node that paging of the WD 300 in the RNA has failed. The paging failure notification message may comprise an indication, such as an indicator indicating, that the second radio network node 400A has DL data buffered or pending. In one or more example methods, the paging failure notification message is a release request message, such as a UE Context Release Request message, requesting the core network node to release the UE context for the WD 300.

The paging failure notification message may be transmitted over an N2 interface and may thus be an N2 message. The indicator indicating that the second radio network node 400A has DL data buffered or pending may be a temporary RAN identifier assigned to the WD, such as the I-RNTI assigned to the WD 300 in the first RNA or a flag, such as a flag set, indicating that the second radio network node has buffered or pending DL data. This will notify the core network node, such as the AMF, that RAN based paging failed and that DL data still remains in the second radio network node. The indicator indicating that the second radio network node 400A has DL data buffered or pending may only be comprised in the paging failure notification message if pending DL data is available.

The first radio network node 400 may try to retrieve a UE context of the WD 300 directly from the second radio network node 400A by sending a retrieve UE context request message 1007 comprising the RAN temporary identifier, such as the I-RNTI, to the second radio network node 400A. In conjunction with sending the retrieve UE context request, the first radio network node 400 may set up a path for forwarding DL data for the WD 300 from the second radio network node 400A to the first radio network node 400. The path for forwarding the DL data for the WD 300 may be set up by the first radio network node 400 sending a message comprising an Xn-U address 1008 to the second radio network node 400A. The first radio network node may send the retrieve UE context request message 1010 in response to receiving the mobility update message 1004 from the WD 300. The mobility update message may be an RRC Resume message comprising the RAN temporary identifier associated with the WD in the RNA.

The first radio network node 400 may fail 1009 to retrieve the UE context of the WD 300 directly from the second radio network node 400A in response to sending the UE context retrieve request 1007.

Upon failing to retrieve the UE context 1009 of the WD 300 in the RAN, such as directly from the second radio network node 400A, the first radio network node 400 may send a message 1010 requesting assistance in retrieving the UE context and/or DL data of the WD to the CN node 600. The message comprises a temporary identifier assigned to the WD, such as the RAN temporary identifier, such as the I-RNTI. The message 1010 requesting assistance in retrieving the UE context and/or DL data may request the CN node 600 to try to resolve the I-RNTI that may be part of a UE Resume Request from the WD. The CN node 600 may be an AMF and may or may not be the same AMF that has been serving the WD in the RNA.

The CN node 600 may try to resolve 1011 the RAN temporary identifier, such as may try to find the radio network node associated with the RAN temporary identifier, using the temporary identifier assigned to the WD, such as the RAN temporary identifier, such as the I-RNTI. The I-RNTI consist of a WD identifier and an identifier of the radio network node, such as a gNB identifier (I-RNTI=UE ID+gNB ID). Hence, the CN node may identify the second radio network node based on the I-RNTI. In case the CN node is not the core network node, such as the AMF, serving the radio network node associated with the RAN temporary identifier, the core network node may resolve this issue by first asking the radio network node (based on the I-RNTI=UE ID+gNB ID) which core network node is the serving core network node, such as is the serving AMF, for the radio network node associated with the RAN temporary identifier. Then the core network node 600 receiving the message 1010 requesting assistance in retrieving the UE context and/or DL data may forward the request to the core network node, such as the AMF, serving the radio network node associated with the RAN temporary identifier.

Upon the CN node 600, such as the AMF, not being able to retrieve the UE context of the WD, such as not being able to resolve the RAN temporary identifier, the core network node 600 may notify the first radio network node by transmitting a failure to retrieve message 1012 indicating the failure to retrieve to the first radio network node 400.

The first radio network node 400 may reject the RNAU message and may send an RNAU reject message 1013 to the WD 300 indicating that the RNA Mobility Update 1004 has been rejected. Upon receiving the RNAU reject message 1013 the WD 300 may perform a NAS recovery procedure with the core network node 600, such as with the AMF. The NAS recovery procedure may be performed using the CN temporary identifier associated with the WD. The CN temporary identifier may be one or more of a 5G-Temporary Mobile Subscriber Identity (5G-TMSI), a 5G-S-Temporary Mobile Subscriber Identity (5G-S-TMSI) and a Globally Unique AMF Identifier (GUAMI).

Upon the CN node 600, such as the AMF, being successful in resolving the RAN temporary identifier and being able to identify the second radio network node associated with the RAN temporary identifier, the CN node 600 may check with the second radio network node whether the UE context of the WD 300 remains at the second radio network node 400A by initiating 1014 a UE context and/or DL data transfer from the second radio network node 400A to the first radio network node 400.

Upon the second radio network node 400A still having the UE context, the second radio network node 400A may forward the UE context 1015 and/or the DL data 1016 to the first radio network node 400. The UE context 1015 may be forwarded via the core network as a transparent container, as the core network node does not need to understand the content. The DL data 1016 may be sent directly or indirectly (same data forwarding used when CN assisted HO is performed, see TS 23.502 clause 4.9.1.3) from the second radio network node 400A to the first radio network node 400. In one or more example methods, the UE context 1015 and/or the DL data 1016 may be forwarded from the second radio network node 400a to the first radio network node using the XnAP (as defined in 3GPP TS 38.423 v16.7.0, clause 8.2.4.2). An Xn User plane (Xn-U) interface may be configured to forward any pending data, such as data buffered by the second radio network node 400A, from the second radio network node 400A to the first radio network node 400.

The reception of DL data from the second radio network node 400A at the first radio network node 400 may, if the WD 300 has not been released from an RRC Connected state, trigger the first radio network node 400A to deliver, such as to send, the DL data 1017 to the WD 300. The first radio network node 400A may follow legacy procedures before releasing 1018 the WD 300 from the RRC Connected state, such as to an RRC Idle state or an RRC Inactive state.

The first radio network node 400 may issue a path switch with the serving AMF/SMF and request any buffered data in the old RAN node.

The first radio network node 400 may send a path switch request 1019 to the core network node 600. The path switch request may be sent by the first radio network node 400 to request the core network node 600 to configure user plane resources for a tunnel to the first radio network node via an N3 interface, such as an N3 tunnel. The path switch request 1019 may request the core network node 600 to switch a termination point of the N3 tunnel from the second radio network node 400A to the first radio network node 400.

The core network node 600 may send a session modification request 1020 to the UPF, requesting the UPF 800 to modify a user plane, such modifying the PDU session(s) configuration comprising for example Forwarding data rules (FDR) and the Tunnel Endpoint ID (TEID) of the first radio network node, to move a tunnel on the N3 interface, for the WD 300 from the second radio network node 400A to the first radio network node 400.

The UPF 800 may modify the user plane and may respond to the session modification request with a session modification response 1021 to the core network node 600.

Upon receiving the session modification response, the core network node 600 may send a path switch response 1022, such as a path switch request acknowledge (ACK), to the first radio network node 400. The path switch response 1022 may indicate to the first radio network node 400 that a user plane path switch has been successfully completed in the core network.

In one or more example methods, the first radio network node 400 may send a RRC Release with suspend message 1023 to the WD 300. When the RRC connection is suspended, the WD 300 may store the UE AS context and any configuration received from the network, and may transit to RRC-Inactive state.

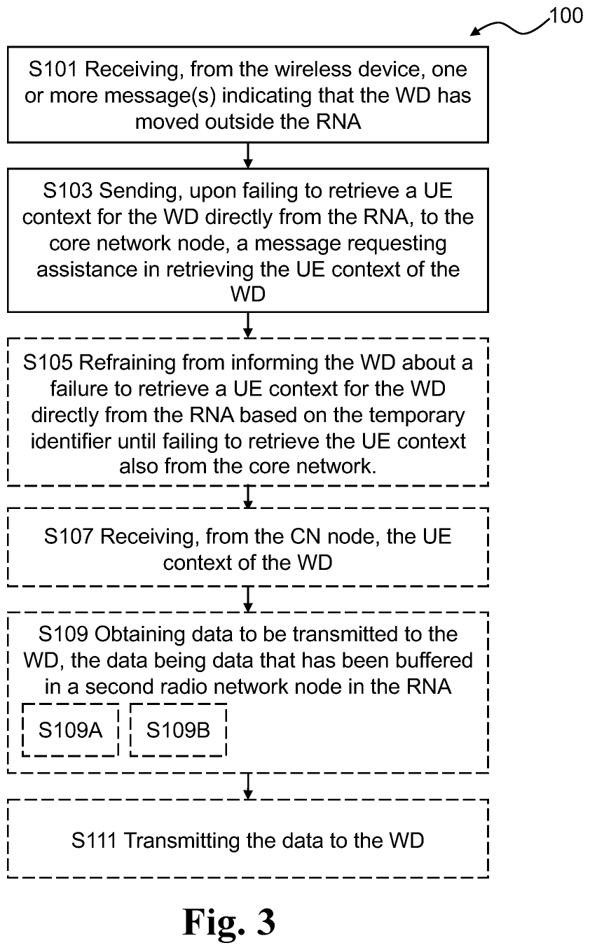

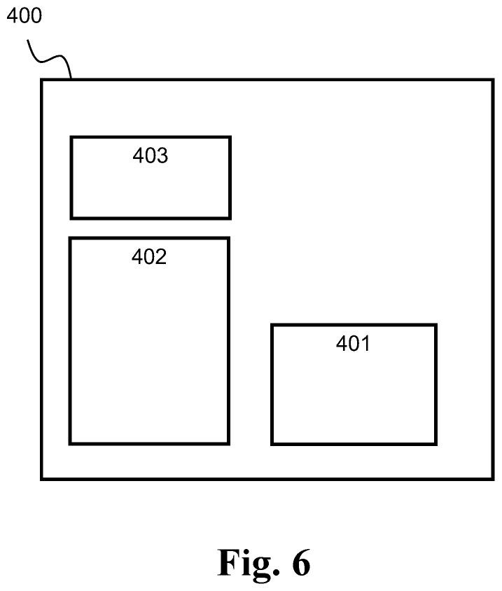

FIG. 3 shows a flow diagram of an example method 100, performed by a first radio network node according to the disclosure, for handling mobility of a wireless device connected to a core network node. The first radio network node is outside a radio access network notification area, RNA, associated with the wireless device. The first radio network node is the target radio network node disclosed, such as the first radio network node network node 400 of FIG. 1, FIG. 2A, FIG. 2B and FIG. 6.

The method 100 comprises receiving S101, from the wireless device, one or more message(s) indicating that the WD has moved outside the RNA, wherein the at least one message comprises a temporary identifier assigned to the WD. In one or more example methods, the temporary identifier assigned to the WD is a RAN temporary identifier assigned to the WD in the RNA. In one or more example methods, the radio access network temporary identifier assigned to the WD in the RNA is an I-RNTI. The I-RNTI may be assigned to the WD when the WD enters inactive state, such as RRC Inactive state in the first RNA. The first radio network node may thus instruct the core network node to assist the first radio network node in the retrieval of the UE context and/or DL data for the WD.

In one or more example methods, the temporary identifier assigned to the WD a core network temporary identifier. In one or more example methods, the core network temporary identifier is a 5G-S-TMSI, a 5G-TMSI or a GUAMI. In one or more example methods, the one or more message(s) comprise the core network temporary identifier in addition to the RAN temporary identifier to aid resolving the mobility update, such as the RNAU, from the WD. When the temporary identifier is the core network identifier the paging may be CN initiated. CN initiated paging can be used to recover from RAN based paging failure. Sending the core network temporary identifier may trigger signaling between the WD and the core network to create a new UE context in RAN as the WD assumes the RAN lost the UE context with the WD as the WD has been paged by the CN even though the WD believed it was still in RRC Inactive towards the RAN.

In one or more example methods, at least one of the one or more message(s) indicating that the WD has moved outside the RNA is a mobility update message, such as an RNA update (RNAU) message. In one or more example methods, at least one of the one or more message(s) indicating that the WD has moved outside the RNA is a resume request, such as a message 3 (msg 3) in Random Access Channel (RACH) procedure. In one or more example methods, the mobility update message may be the resume request message, such as the msg 3 in RACH procedure.

The method 100 comprises sending S103 to the core network node, upon failing to retrieve a UE context for the WD directly from the RNA (such as from the second radio network node in the RNA), a message requesting assistance in retrieving the UE context of the WD, wherein the message comprises a temporary identifier assigned to the WD. Retrieving directly herein means using a direct connection, such as not via the core network. The direct connection may for example be a connection using an Xn interface. The first radio network node may try to retrieve the UE context via the Xn interface. The first radio network node may fail due to there being no Xn interface between the first radio network node and a second radio network node. The second radio network node may be the RAN anchor node of the RNA. The target radio network node may send the message requesting assistance to a core network node associated with the access network of the target radio network, such as to an access network AMF of the target radio network node to try to resolve the RAN temporary identifier comprised in the one or more messages from the WD. This core network node associated with the access network of the target radio network node may be the same or a different core network node that is serving the WD, such as the core network node associated with the second radio network node, such as with the RAN anchor node of the WD.

In one or more example methods, the method comprises refraining S105 from informing the WD about a failure to retrieve the UE context for the WD directly from the RNA based on the temporary identifier until failing to retrieve the UE context also from the core network. The message requesting assistance in retrieving the UE context of the WD may be a request to the CN node to help resolve the mobility update message from the WD based on the RAN temporary identifier before rejecting the mobility update. Refraining S105 from informing the WD about a failure to retrieve the UE context may comprise keeping the WD between two states RRC-Inactive and RRC Connected or Idle, for example until receiving a message 4 in the RACH procedure.

In one or more example methods, the method comprises receiving S107, from the CN node, the UE context of the WD. The UE context of the WD may be fully or partially received. In one or more example methods, the first radio network node may receive the entire UE context of the WD including information associated with the second radio network node. In one or more example methods, the first radio network node may receive a partial UE context of the WD, such as the full UE context except the information associated with the second radio network node.

In one or more example methods, the method comprises obtaining S109 data to be transmitted to the WD, such as DL data, the data being data that has been buffered in the second radio network node, such as in the RAN anchor node of the RNA.

In one or more example methods, obtaining S109 comprises sending S109A a request for buffered data, such as the buffered DL data, in the second radio network node. The request may be sent to one or more of the core network node and the second radio network node.

In one or more example methods, obtaining S109 comprises receiving S109B the buffered data from the second radio network node. In one or more example methods, receiving S109B the buffered data may comprise receiving the buffered data directly from the second radio network node, for example via an established Xn interface between the first and the second radio network node. In one or more example methods, receiving S109B the buffered data may comprise receiving the buffered data via the CN node, such as via one or more UPF(s) of the core network.

In one or more example methods, the method comprises transmitting S111 the data to the WD. Upon receiving the buffered, such as pending, DL data, the first radio network node may send the buffered DL data to the WD.

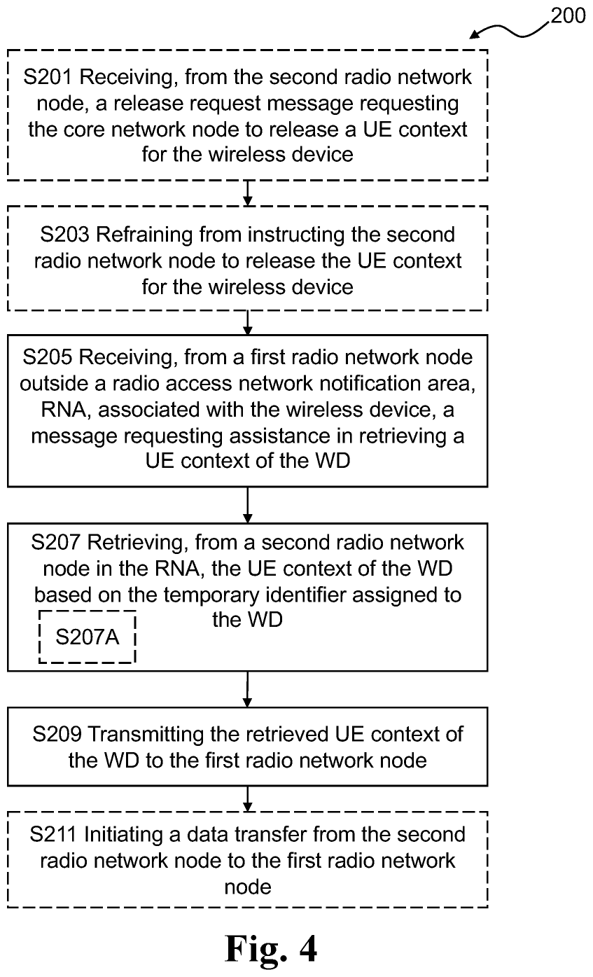

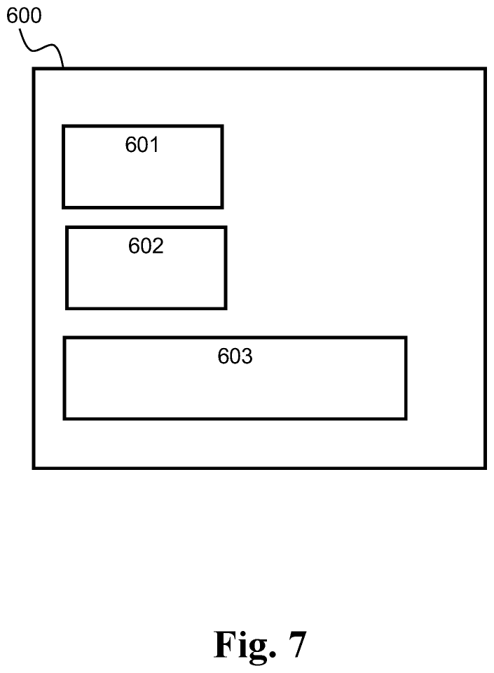

FIG. 4 shows a flow diagram of an example method 200, performed by a core network node according to the disclosure, for handling mobility of a wireless device, wherein the wireless device is connected to the core network node. The core network node is the core network node disclosed herein, such as core network node 600 of FIG. 1, FIG. 2A, FIG. 2B, and FIG. 7. The core network node may be an AMF.

In one or more example methods, the method comprises receiving S201, from the second radio network node, a release request message requesting the core network node to release a UE context for the wireless device, wherein the release request message comprises an indication that the second radio network node has DL data to be transmitted to the wireless device. The indication that the second radio network node has data to transmit may be the RAN temporary identifier or a flag indicating that the second radio network node has pending, such as buffered, DL data to be transmitted to the WD. Hence, the release request message received from the second radio network node may comprise the RAN temporary identifier.

In one or more example methods, the method comprises refraining S203 from instructing the second radio network node to release the UE context for the wireless device. In one or more example methods, refraining S203 is performed for a predetermined time period. In one or more example methods, the time period is an ongoing paging time window for the wireless device. In one or more example methods, refraining S203 is performed until receiving a request for retrieval of a UE context for the WD. The request for retrieval of the UE context for the WD may be received from the first radio network node.

The method 200 comprises receiving S205, from a first radio network node outside an RNA associated with the wireless device, a message requesting assistance in retrieving a UE context of the WD. The message requesting assistance comprises a temporary identifier assigned to the WD. In one or more example methods, the temporary identifier assigned to the WD is a RAN temporary identifier assigned to the WD in the RNA. In one or more example methods, the radio access network temporary identifier assigned to the WD in the RNA is an I-RNTI. In one or more example methods, the temporary identifier assigned to the WD a core network temporary identifier. In one or more example methods, the core network temporary identifier is a 5G-S-TMSI, a 5G-TMSI or a GUAMI. In one or more example methods, the message requesting assistance in retrieving the UE context of the WD comprises the core network temporary identifier, as the core network temporary identifier is known to the core network node. In one or more example methods, the message requesting assistance comprises the core network temporary identifier in addition to the RAN temporary identifier to aid resolving the mobility update, such as the RNAU, from the WD.

The method 200 comprises retrieving S207, from a second radio network node in the RNA, the UE context of the WD based on the temporary identifier assigned to the WD. In one or more example methods, retrieving S207 comprises retrieving S207A, from the second radio network node, the UE context of the WD based on the core network temporary identifier. Upon the second radio network node still holding the UE context for the WD, the second radio network node may forward the UE context of the WD to the first radio network node via the core network node as a transparent container. The core network node may thus be unaware of the content of the transparent container. In one or more example methods, retrieving S207 the UE context may comprise receiving S207B an indication that the second radio network node has data stored and/or buffered which is pending to be transmitted to the WD.

The method 200 comprises transmitting S209 the retrieved UE context of the WD to the first radio network node. The UE context of the WD may be fully or partially transmitted to the first radio network node. In one or more example methods, the CN node may transmit the entire UE context of the WD including information associated with the second radio network node. In one or more example methods, the CN node may transmit a partial UE context of the WD, such as the full UE context except for example the information associated with the second radio network node.

In one or more example methods, upon receiving an indication that the second radio network node has data to transmit to the WD, the method comprises initiating S211 a data transfer from the second radio network node to the first radio network node. The indication that the second radio network node has data to transmit may be received from the second radio network node. Initiating S211 may comprise providing S211A an Internet Protocol (IP) routing connection via the user plane between the first radio network node and the second radio network node. IP Routing refers to a set of protocols that determine a path that data follows to travel across one or more networks from its source to its destination, such as from the second radio network node to the first radio network node. The data may be transferred, such as routed, directly from the second radio network node to the first radio network node or via one or more CN node(s).

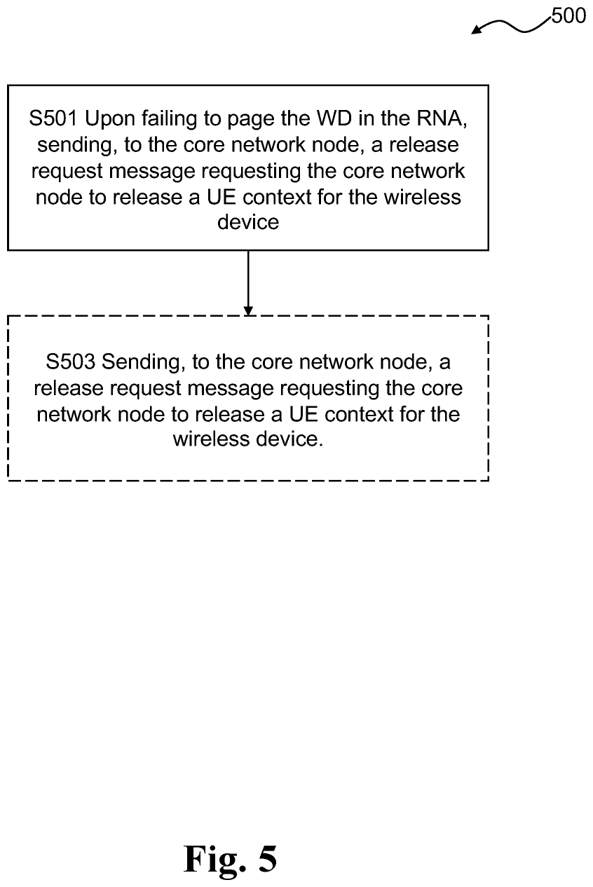

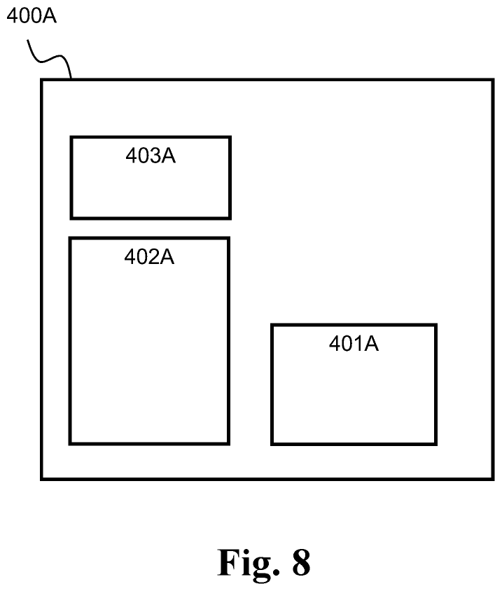

FIG. 5 shows a flow diagram of an example method 500, performed by a second radio network node according to the disclosure, for handling mobility of a wireless device. The wireless device is connected to a core network node. The first radio network node serves a radio access network notification area, RNA, associated with the wireless device. The second radio network node is the RAN anchor node disclosed herein, such as the second radio network node 400A of FIG. 1, FIG. 2A, FIG. 2B, and FIG. 8. The second radio network node is a RAN anchor node of an RNA associated to the WD. The RNA associated to the WD comprises a set of cells or radio network nodes where the RAN anchor node or cells served by the RAN anchor node is one of them. The RAN anchor node herein is a radio network node currently having a UE context with the WD, such as the last serving radio network node of the WD. In one or more example methods, the WD has no active radio connection to the second radio network node. In other words, the WD may be in RRC Inactive state towards the second radio network node.

The second radio network node may have, such as may have received via the core network node, data, such as DL data, to be transmitted to the WD. The second radio network node may buffer the DL data until the next paging time window of the WD starts.

In one or more example methods, the method comprises paging S501 the WD in the RNA using a paging message to the WD in the first RNA a temporary identifier (ID) associated with the WD, such as a radio access network temporary ID, such as an I-RNTI assigned to the WD in the first RNA. The I-RNTI may be assigned to the WD by the second radio network node when the WD enters inactive state, such as RRC Inactive state in the first RNA. The second radio network node may thus instruct the core network node to release the UE context for the WD.

The method 500 comprises, upon failing to page the WD in the RNA, sending S503, to the core network node, a release request message requesting the core network node to release a UE context for the wireless device. In one or more example methods, the release request message comprises an indication that the second radio network node has DL data to be transmitted to the wireless device. The indication that the second radio network node has data to transmit may be the RAN temporary identifier or a flag indicating that the second radio network node has pending, such as buffered, DL data to be transmitted to the WD. Hence, the release request message received from the second radio network node may comprise the RAN temporary identifier. By sending the release request message comprising the indication that the second radio network node has DL data to be transmitted, the CN node can be made aware of pending DL data in the second radio network node, which enables the CN node to page (using CN paging) the WD in a wider geographical area, such as in an RA of the WD, based on the pending DL data in the second radio network node. Without the release request message comprising the indication that the second radio network node has DL data to be transmitted, the CN node would not be aware of there being pending DL data that has not been transmitted to the WD and could not initiate paging of the WD based on the pending DL data.

The second radio network node may not be aware of the reason for the failure to page the WD. The failure to page the WD may be due to the WD having moved outside the RNA of the second radio network node, the WD being out of power or the WD being out of coverage of the second radio network node.

In one or more example methods, the release request message requesting the core network node to release a UE context, such as the UE Context Release request message, for the wireless device may be sent upon receiving a request for UE context of the WD from the CN node.

In one or more example methods, the CN node may send a UE context release message to the second radio network node after retrieving the UE context from the second RAN node.

FIG. 6 shows a block diagram of an example first radio network node 400 according to the disclosure. The first radio network node 400 comprises memory circuitry 401, processor circuitry 402, and an interface 403. The interface 403 may be a wireless interface and/or a wired interface. The first radio network node 400 may be configured to perform any of the methods disclosed in FIG. 3. In other words, the first radio network node 400 may be configured for handling mobility of a wireless device connected to a core network node. The first radio network node 400 may be a target radio network node of the WD during mobility of the WD.

The first radio network node 400 is configured to communicate with a WD, such as the WD disclosed herein, using a wireless communication system.

The interface 403 is configured for wireless communications via a wireless communication system, such as a 3GPP system, such as a 3GPP system supporting one or more of: E-UTRA, LTE, New Radio, NR, Narrow-band IoT, NB-IoT, and Long Term Evolution-enhanced Machine Type Communication, LTE-M, millimeter-wave communications, such as millimeter-wave communications in licensed bands, such as device-to-device millimeter-wave communications in licensed bands.

The first radio network node 400 is configured to receive from the WD, for example via the interface 403, one or more message(s) indicating that the WD has moved outside the RNA, wherein the at least one message comprises a temporary identifier assigned to the WD.

The first radio network node 400 is configured to, upon failing to retrieve a UE context for the WD directly from the RNA, send to the core network node, for example via the interface 403, a message requesting assistance in retrieving a User Equipment, UE, context of the WD, wherein the message comprises a temporary identifier assigned to the WD.

Processor circuitry 402 is optionally configured to perform any of the operations disclosed in FIG. 3 (such as any one or more of S101, S103, S105, S107, S109, S109A, S109B, S111). The operations of the first radio network node 400 may be embodied in the form of executable logic routines (for example, lines of code, software programs, etc.) that are stored on a non-transitory computer readable medium (for example, memory circuitry 401) and are executed by processor circuitry 402).

Furthermore, the operations of the first radio network node 400 may be considered a method that the first radio network node 400 is configured to carry out. Also, while the described functions and operations may be implemented in software, such functionality may also be carried out via dedicated hardware or firmware, or some combination of hardware, firmware and/or software.

Memory circuitry 401 may be one or more of a buffer, a flash memory, a hard drive, a removable media, a volatile memory, a non-volatile memory, a random access memory (RAM), or other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 6). Memory circuitry 401 is considered a non-transitory computer readable medium.

Memory circuitry 401 may be configured to store information, such as information indicative of one or more of a PTW of the WD, remaining POs in the PTW, a UE context of the WD, DL data to be transmitted to the WD, and one or more temporary identifiers associated with the WD, in a part of the memory.

FIG. 7 shows a block diagram of an example core network node 600 according to the disclosure. The core network node 600 comprises memory circuitry 601, processor circuitry 602, and an interface 303. The core network node 600 may be configured to perform any of the methods disclosed in FIG. 4. In other words, the core network node 600 may be configured for handling mobility of a wireless device.

The core network node 600 is configured to receive from a first radio network node outside an RNA associated with the wireless device, such as via the interface 603, a message requesting assistance in retrieving a UE context of the WD, wherein the message comprises a temporary identifier assigned to the WD.

The core network node 600 is configured to retrieve, such as via the interface 603, the UE context of the WD from a second radio network node in the RNA based on the temporary identifier assigned to the WD.

The core network node 600 is configured to transmit, such as via the interface 603, the retrieved UE context of the WD to the first radio network node.

The interface 603 is configured for communications with radio network nodes operating in a wireless communication system, such as a 3GPP system, such as a 3GPP system supporting one or more of: E-UTRA, LTE, New Radio, NR, Narrow-band IoT, NB-IoT, and Long Term Evolution-enhanced Machine Type Communication, LTE-M, millimeter-wave communications, such as millimeter-wave communications in licensed bands, such as device-to-device millimeter-wave communications in licensed bands.

The core network node 600 is optionally configured to perform any of the operations disclosed in FIG. 4 (such as any one or more of S201, S203, S205, S207, S207A, S207B, S209, S211). The operations of the core network node 600 may be embodied in the form of executable logic routines (for example, lines of code, software programs, etc.) that are stored on a non-transitory computer readable medium (for example, memory circuitry 601) and are executed by processor circuitry 602).

Furthermore, the operations of the core network node 600 may be considered a method that the core network node 600 is configured to carry out. Also, while the described functions and operations may be implemented in software, such functionality may also be carried out via dedicated hardware or firmware, or some combination of hardware, firmware and/or software.

Memory circuitry 601 may be one or more of a buffer, a flash memory, a hard drive, a removable media, a volatile memory, a non-volatile memory, a random access memory (RAM), or other suitable device. In a typical arrangement, memory circuitry 601 may include a non-volatile memory for long term data storage and a volatile memory that functions as system memory for processor circuitry 602. Memory circuitry 601 may exchange data with processor circuitry 602 over a data bus. Control lines and an address bus between memory circuitry 601 and processor circuitry 602 also may be present (not shown in FIG. 7). Memory circuitry 601 is considered a non-transitory computer readable medium.

Memory circuitry 601 may be configured to store information, such as information indicative of one or more of a PTW of the WD, remaining POs in the PTW, a UE context of the WD, and DL data to be transmitted to the WD, and one or more temporary identifiers associated with the WD, in a part of the memory.

FIG. 8 shows a block diagram of an example second radio network node 400A according to the disclosure. The second radio network node 400A comprises memory circuitry 401A, processor circuitry 402A, and an interface 403A. The interface 403A may be a wired interface and/or a wireless interface. The second radio network node 400A may be configured to perform any of the methods disclosed in FIG. 5. In other words, the second radio network node 400A may be configured for handling mobility of a wireless device. The second radio network node 400A may be a RAN anchor node of the WD in the RNA.

The second radio network node 400A is configured to communicate with a WD, such as the WD disclosed herein, using a wireless communication system. The second radio network node 400A is configured to communicate with a network node, such as a core network node or another radio network node via a wired interface.

The interface 403A is configured for wireless communications via a wireless communication system, such as a 3GPP system, such as a 3GPP system supporting one or more of: E-UTRA, LTE, New Radio, NR, Narrow-band IoT, NB-IoT, and Long Term Evolution-enhanced Machine Type Communication, LTE-M, millimeter-wave communications, such as millimeter-wave communications in licensed bands, such as device-to-device millimeter-wave communications in licensed bands.

The second radio network node 400A is configured to send, for example via the interface 403A, a release request message to the core network node requesting the core network node to release a UE context for the wireless device, wherein the release request message comprises an indication that the second radio network node has DL data to be transmitted to the wireless device.

Processor circuitry 402A is optionally configured to perform any of the operations disclosed in FIG. 5 (such as any one or more of S501, S503). The operations of the network node 400 may be embodied in the form of executable logic routines (for example, lines of code, software programs, etc.) that are stored on a non-transitory computer readable medium (for example, memory circuitry 401A) and are executed by processor circuitry 402A).

Furthermore, the operations of the second radio network node 400A may be considered a method that the second radio network node 400 is configured to carry out. Also, while the described functions and operations may be implemented in software, such functionality may also be carried out via dedicated hardware or firmware, or some combination of hardware, firmware and/or software.

Memory circuitry 401A may be one or more of a buffer, a flash memory, a hard drive, a removable media, a volatile memory, a non-volatile memory, a random access memory (RAM), or other suitable device. In a typical arrangement, memory circuitry 401A may include a non-volatile memory for long term data storage and a volatile memory that functions as system memory for processor circuitry 402A. Memory circuitry 401A may exchange data with processor circuitry 402A over a data bus. Control lines and an address bus between memory circuitry 401A and processor circuitry 402A also may be present (not shown in FIG. 8). Memory circuitry 401A is considered a non-transitory computer readable medium.

Memory circuitry 401A may be configured to store information, such as information indicative of one or more of a PTW of the WD, remaining POs in the PTW, a UE context of the WD, and DL data to be transmitted to the WD, and one or more temporary identifiers associated with the WD, in a part of the memory.

Examples of methods and products (first radio network node, core network node and second radio network node) according to the disclosure are set out in the following items:

Item 1. A method, performed by a first radio network node, for handling mobility of a wireless device connected to a core network node, wherein the first radio network node is outside a radio access network notification area, RNA, associated with the wireless device, the method comprising:
receiving (S101), from the wireless device, one or more message(s) indicating that the WD has moved outside the RNA, wherein the at least one message comprises a temporary identifier assigned to the WD, and
sending (S105), upon failing to retrieve a UE context for the WD directly from the RNA, to the core network node, a message requesting assistance in retrieving a User Equipment, UE, context of the WD, wherein the message comprises a temporary identifier assigned to the WD.

Item 2. The method according to Item 1, wherein the method comprises refraining (S107) from informing the WD about a failure to retrieve a UE context for the WD directly from the RNA based on the temporary identifier until failing to retrieve the UE context also from the core network.

Item 3. The method according to anyone of the Items 1-2, wherein the temporary identifier assigned to the WD is one or more of a radio access network temporary identifier assigned to the WD in the RNA and a core network temporary identifier.

Item 4. The method according to Item 3, wherein the radio access network temporary identifier assigned to the WD in the RNA is an Inactive Radio Network Temporary Identifier, I-RNTI, assigned to the RNA.

Item 5. The method according to any one of the Items 3-4, wherein the core network temporary identifier is a 5G-S-Temporary Mobile Subscriber Identity, 5G-S-TMSI.

Item 6. The method according to any one of the previous Items, wherein at least one of the one or more message(s) indicating that the WD has moved outside the RNA is a mobility update message.

Item 7. The method according to any one of the previous Items, wherein the method comprises:
receiving (S109), from the CN node, the UE context of the WD.

Item 8. The method according to any one of the previous Items, wherein the method comprises:
obtaining (S111) data to be transmitted to the WD, the data being data that has been buffered in a second radio network node in the RNA.

Item 9. The method according to Item 8, wherein obtaining (S111) comprises sending (S111A) a request for buffered data in the second radio network node.

Item 10. The method according to Item 8, wherein obtaining (S111) comprises receiving (S111B) the buffered data from the second radio network node.

Item 11. The method according to any one of the Items 8-10, wherein the method comprises:
transmitting (S113) the data to the WD.

Item 12. A method performed by a core network node, for handling mobility of a wireless device, wherein the wireless device is connected to the core network node, the method comprising:
receiving (S205), from a first radio network node outside a radio access network notification area, RNA, associated with the wireless device, a message requesting assistance in retrieving a User Equipment, UE, context of the WD, wherein the message comprises a temporary identifier assigned to the WD,
retrieving (S207), from a second radio network node in the RNA, the UE context of the WD based on the temporary identifier assigned to the WD, and
transmitting (S209) the retrieved UE context of the WD to the first radio network node.

Item 13. The method according to Item 12, wherein the method comprises:
upon receiving an indication that the second radio network node has data to transmit to the WD, initiating (S211) a data transfer from the second radio network node to the first radio network node.

Item 14. The method according to Item 12 or 13, wherein the method comprises:
receiving (S201), from the second radio network node, a release request message requesting the core network node to release a UE context for the wireless device, wherein the release request message comprises an indication that the second radio network node has DL data to be transmitted to the wireless device, and
refraining (S203) from instructing the second radio network node to release the UE context for the wireless device.

Item 15. The method according to Item 14, wherein refraining (S203) is performed for a predetermined time period.

Item 16. The method according to Item 15, wherein the time period is an ongoing paging time window for the wireless device.

Item 17. The method according to Item 14, wherein refraining (S203) is performed until receiving a request for retrieval of a UE context for the WD.

Item 18. The method according to anyone of the Items 12-17, wherein the temporary identifier assigned to the WD is one or more of a radio access network temporary identifier assigned to the WD in the RNA and a core network temporary identifier.

Item 19. The method according to Item 18, wherein the radio access network temporary identifier assigned to the WD in the RNA is an Inactive Radio Network Temporary Identifier, I-RNTI.

Item 20. The method according to any one of the Items 18-19, wherein the core network temporary identifier is a 5G-S-Temporary Mobile Subscriber Identity, 5G-S-TMSI.

Item 21. The method according to any one of the Items 18-20, wherein the message requesting assistance in retrieving the UE context of the WD comprises a core network temporary identifier, and wherein retrieving (S207) comprises retrieving (S207A), from the second radio network node, the UE context of the WD based on the core network temporary identifier.

Item 22. A method performed by a second radio network node, for handling mobility of a wireless device, wherein the wireless device is connected to a core network node and wherein the second radio network node serves a radio access network notification area, RNA, associated with the wireless device, the method comprising:
upon failing to page the WD in the RNA, sending (S501), to the core network node, a release request message requesting the core network node to release a UE context for the wireless device, wherein the release request message comprises an indication that the second radio network node has DL data to be transmitted to the wireless device.

Item 23. A first radio network node comprising memory circuitry, processor circuitry, and a wireless interface, wherein the first radio network node is configured to perform any of the methods according to any of Items 1-11.

Item 24. A core network node comprising memory circuitry, processor circuitry, and a wireless interface, wherein the radio network node is configured to perform any of the methods according to any of Items 12-21.

Item 25. A second radio network node comprising memory circuitry, processor circuitry, and a wireless interface, wherein the second radio network node is configured to perform any of the methods according to Item 22.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-8 comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

In the following appendix A an example implementation of the methods disclosed herein will be discussed.

### APPENDIX A

In the following an example implementation of the methods disclosed herein will be discussed.

### Background

During Rel-17 SA2 discuss the request from RAN2 to support long eDRX (longer than 10.24 s) when a RedCap UE is in RRC-Inactive. During this discussion we propose a solution based on RAN performing extended buffering and reuse of legacy mechanisms to handle the cases when MT signalling and MT data arrives at the RAN node. This is typically a rare case as this devices type that use long eDRX are driven by UL traffic.

The proposal can be for example:
a) Allow eDRX>10.24 s for RRC-Inactive
b) RAN may buffer MT data in case it judges it is feasible, or drops it which could lead to that RAN triggers the CM release (N2 msg), “kind of paging failure”.
c) If NAS data can't be delivered (page the UE within the NAS timer range i.e. <10.24 s), then RAN trigger the CM release (N2 msg—UE context release request), “kind of paging failure”
d) It may be needed that RAN together with the CM release request also updates the CN with the UE's eDRX RRC-Inactive configuration based on RRC configuration. So the CN knows when to issue a retransmission of the NAS msg.
e) CN does NOT handle HLcom in CM-connected state.

The following considerations have been taken account:
Solutions based on buffering in RAN come with the drawback/challenge that DL data buffered in gNB may be lost when UE resumes at a gNB that has no connectivity with the old gNB. Hence we will systematically encounter failed network data delivery. As per your proposal, gNB drops the DL data because/when it is not able to buffer it and the UE is released to CM-Idle which will result again in failed network data delivery and does not address the actual problem. The net result will be that UE will be cycled through all the RRC and CM states with all the signaling that it implies. The cleanest way to address that problem is to reuse the buffering in the CN that is already supported by HLCOM.
While in eDRX, a UE may move between RNAs that have no connectivity. During this time period DL data may arrive and be buffered at old gNB that holds the UE Context. When the UE leaves the eDRX cycle, it may be under coverage and be served by a gNB that has no connectivity to old gNB. Thus the DL data buffered at old gNB can't be forwarded.

Based on these considerations, the solution is updated with new functionality addressing how to handle UE mobility outside the RNA and when a Xn interface between the new and old RAN node does not exist.

### Proposal

The following solution is proposed for the study.

### 6.x Solution #x: Long eDRX with RAN buffering

### 6.x.1 Introduction

This solution relates the KI #1 and proposes a solution where extended buffering of MT data is in RAN when a RedCap UE uses long eDRX. Furthermore, the solution supports notification to the AMF for UE unavailability due to use of long eDRX as response to MT signaling.

### 6.x.2 Functional Description

This solution addresses KI #1 and the following principles are used:
Allow eDRX >10.24 s for RRC-Inactive.
RAN is responsible for paging and will apply paging strategy considering the UE PTW configuration.
The PTW configuration is provided to NG-RAN in the RRC Inactive Assistance Information as described in TS 23.501 [x] and TS 38.413 [y].
RAN may buffer MT data in case it finds it feasible or triggers the UE context release (N2 msg).

NOTE 1: The N2 message could be the UE Context Release Request message which RAN use to notify the AMF of RAN paging failure. The message may need to be extended to include that the failure was due to eDRX configuration. TSG RAN3 is responsible for N2 messages and their format.
If NAS message can't be delivered (page the UE within the NAS retransmission timer range i.e. <10.24 s), then RAN triggers the UE context release (N2 msg—UE context release request), with cause value indicating that the UE is not currently reachable for MT signaling.

NOTE 2: The N2 message used to deliver the failure could be the UE Context Release Request message which RAN use to notify the AMF of RAN paging failure. The message may need to be extended to include that the failure was due to eDRX configuration. Sending an N2 notification instead of UE Context release request could be an alternative to prevent that the UE is moved to CM-Idle state in the AMF. TSG RAN3 is responsible for N2 messages and their format.
The Core network does not handle HLcom features, see TS 23.501 [x] clause 5.31.8, in CM-Connected state. Specifically the core network does not support extended buffering (as the extended buffering is done in RAN), notification service for UE Reachability, Availability after DDN failure, and Downlink Data Delivery Status.

RAN is responsible for RAN based paging within a RAN Notification Area (RNA). Long eDRX may increase the possibility that UE moved outside the RNA and possible further away from the RNA. It is proposed that UE mobility and buffered MT data in the old RAN anchor Node should be handled based on the following principles:
In case the new gNB, inside or outside the RNA, has an Xn interface between the old RAN anchor node and the new gNB, then the new gNB can retrieve the UE context (based on procedures in TS 38.413) and also retrieve the extended buffered MT data and deliver the data to the UE.
In case the new gNB is outside the RNA and has NOT an Xn interface between the new gNB and old RAN anchor node, the new gNB is not able to retrieve the UE context and extended buffered Data from the old RAN anchor node. To avoid systematic failure to deliver the extended buffered data to the UE, it is proposed that the new gNB can request assistance from the Core Network in retrieving the UE context and extended buffered data.
As an alternative or a complement to the new gNB requesting assistance to retrieve the buffered data, the old gNB may request the AMF to escalate the paging in a wider area.

Editor's Note: It is FFS if any changes is needed to the N2 message sent by the old RAN node. Furthermore, to make efficient use of this alternative it would be good if the N2 message is sent while there are POs remaining in the PTW.

### 6.x.3 Procedures

6.x.3.1 Procedure How to Handle MT Signaling when UE in RRC-Inactive State with Long eDRX
FIG. 6.x.3.1-1: Procedure for Handling MT Signalling when UE is in RRC-Inactive with Long eDRX
0. UE is in RRC-Inactive/CM-Connected state configured by the RAN node to apply long eDRX in RRC-Inactive.
NOTE 1: The eDRX value could be either the value received by the AMF during the registration or a different eDRX value configured by RAN when the UE is released to RRC-Inactive.
1. The AMF send NAS message towards the UE.
2. The RAN node determines when the UE will become reachable next time according to the eDRX scheme. If the UE will become reachable before NAS retransmission timer expires, then the RAN will page the UE and deliver the NAS message to the UE according to step 6.
3. Optional: The RAN node will send a failure to deliver the NAS message if the UE will not become reachable before NAS retransmission timer expires.

NOTE 2: The N2 message used to deliver the failure could be the UE Context Release Request message which RAN use to notify the AMF of RAN paging failure. The message may need to be extended to include that the failure was due to eDRX configuration. TSG RAN3 is responsible for N2 messages and their format.
4. Optional: The AMF will decide whether to wait until the UE becomes reachable next time based on the eDRX scheme or to release the UE context in RAN and move the UE to CM-Idle state.
NOTE 3: The AMF may use the eDRX value stored in the MM UE context to determine when the UE becomes reachable again.
5. Optional: The AMF retransmits the NAS message in conjunction to the next PTW.
6. RAN B pages the UE and delivers the MT NAS message.
   6.x.3.2 Procedure How to Handle MT Data when UE in RRC-Inactive State with Long eDRX
   FIG. 6.x.3.2-1: Procedure for Handling MT Data when UE is in RRC-Inactive with Long eDRX
0. UE is in RRC-Inactive/CM-Connected state configured by the RAN node to apply long eDRX in RRC-Inactive.
NOTE 1: The eDRX value could be either the value received by the AMF during the registration or a different eDRX value configured by RAN when the UE is released to RRC-Inactive.
1. MT Data for the UE is forwarded to the RAN node.
2. The RAN node determines when the UE will become reachable next time according to the eDRX scheme. The RAN may decide to buffer the DL data until next PTW, then the RAN will page the UE and deliver the DL data to the UE according to step 5.
3. Optional: The RAN node will send a failure to page the UE if the time until the UE becomes reachable is longer than the maximum buffering time configuration in RAN or if RAN based paging failed due to lack of response from the UE.
NOTE 2: The N2 message used to deliver the failure could be the UE Context Release Request message which RAN use to notify the AMF of RAN paging failure. The message may need to be extended. TSG RAN3 is responsible for N2 messages and their format.
4. Optional: The AMF may decide release the UE context in RAN and move the UE to CM-Idle state. RAN drops the MT data after receiving the UE Context Release message. Alternatively, the AMF may decide to escalate the paging in the Registration Area (RA) i.e to RAN nodes outside the RNA. If the AMF is able to page the UE, then the AMF triggers data forwarding from the old RAN node to the new RAN node instead of sending the UE Context Release message to the old RAN node.
NOTE 3: The AMF may use the eDRX value stored in the MM UE context to determine when the UE becomes reachable again. Data forwarding between two RAN nodes could reuse steps used for N2 based handover in TS 23.502 clause 4.9.1.3.
Editors' Note: The paging escalation is an alternative or a complement to the new gNB requesting assistance to retrieve the buffered data in 6.x.3.3. It is FFS if any changes are needed to the N2 message sent in step 3. Furthermore, to make efficient use of this alternative it would be good if the N2 message in step 3 is sent while there are POs remaining in the PTW.
5. RAN pages the UE and delivers the DL data.
   6.x.3.3 Procedure How to Handle UE Mobility Outside the RNA

### FIG. 6.x.3.3-1: Procedure for Handling UE Mobility Outside the RNA

0. UE is in RRC-Inactive/CM-Connected state configured by the RAN node to apply long eDRX in RRC-Inactive.
NOTE: The eDRX value could be either the value received by the AMF during the registration or a different eDRX value configured by RAN when the UE is released to RRC-Inactive.
1. MT Data to the UE is forwarded to the old RAN node.
2. The UE detects that it is outside the configured RNA and send an RNA Update due to mobility to the new RAN node.
3. If the new RAN is not able to retrieve the UE context from the old RAN node e.g. due to lack of Xn interface, then the new RAN node will send a N2 message requesting assistance from the AMF to retrieve the UE context.
4. The AMF, based on the received UE temporary (i.e. I-RNTI which includes the ID of the old RAN node), tries to retrieve the UE context from the old RAN node. If the AMF is not able to retrieve the UE context, then the AMF responds to the new RAN node with a failure to do so. Based on this failure the new RAN node will reject the RNA Update due to mobility.
5. The AMF request to retrieve the UE context from the old RAN node.
6. The Old RAN node forwards the UE context as a transparent container to the AMF and then the AMF forwards the UE context to the old RAN node
7. If the old RAN indicated to the AMF that the RAN has buffered data to the UE, then the AMF triggers data forwarding between the old RAN node and the new RAN node.
NOTE: It is proposed to reuse data forward principle/procedure from N2 based handover as specified in TS 23.502 [y] clause 4.9.1.3.
8. If the new RAN node received DL data, the new RAN node delivers the data to the UE before releasing the UE with new RNA configuration. The new RAN node also performs path switch procedure according to TS 23.502 [y] clause 4.9.1.2.2.

1. A method, performed by a first radio network node, for handling mobility of a wireless device (WD) connected to a core network (CN) node, wherein the first radio network node is outside a radio access network notification area (RNA) associated with the wireless device, the method comprising:
receiving, from the wireless device, one or more message(s) indicating that the WD has moved outside the RNA, wherein the at least one message comprises a temporary identifier assigned to the WD, and
sending, upon failing to retrieve a UE context for the WD directly from the RNA, to the core network node, a message requesting assistance in retrieving a User Equipment (UE) context of the WD, wherein the message comprises a temporary identifier assigned to the WD.

2. The method according to claim 1, wherein the method comprises refraining from informing the WD about a failure to retrieve a UE context for the WD directly from the RNA based on the temporary identifier until failing to retrieve the UE context also from the core network.

3. The method according to claim 1, wherein the temporary identifier assigned to the WD is one or more of a radio access network temporary identifier assigned to the WD in the RNA and a core network temporary identifier.

4. The method according to claim 3, wherein the radio access network temporary identifier assigned to the WD in the RNA is an Inactive Radio Network Temporary Identifier (I-RNTI) assigned to the RNA.

5. The method according to claim 3, and wherein the core network temporary identifier is a 5G-S-Temporary Mobile Subscriber Identity (5G-S-TMSI).

6. The method according to claim 1, wherein at least one of the one or more message(s) indicating that the WD has moved outside the RNA is a mobility update message.

7. The method according to claim 1, wherein the method comprises:
receiving, from the CN node, the UE context of the WD.

8. The method according to claim 1, wherein the method comprises:
obtaining data to be transmitted to the WD, the data being data that has been buffered in a second radio network node in the RNA.

9. The method according to claim 8, wherein obtaining comprises sending a request for buffered data in the second radio network node.

10. The method according to claim 8, wherein obtaining comprises receiving the buffered data from the second radio network node.

11. The method according to claim 8, wherein the method comprises:
transmitting the data to the WD.

12. A method performed by a core network (CN) node, for handling mobility of a wireless device (WD), wherein the wireless device is connected to the core network node, the method comprising:
receiving, from a first radio network node outside a radio access network notification area (RNA) associated with the wireless device, a message requesting assistance in retrieving a User Equipment (UE) context of the WD, wherein the message comprises a temporary identifier assigned to the WD,
retrieving, from a second radio network node in the RNA, the UE context of the WD based on the temporary identifier assigned to the WD, and
transmitting the retrieved UE context of the WD to the first radio network node.

13. The method according to claim 12, wherein the method comprises:
upon receiving an indication that the second radio network node has data to transmit to the WD, initiating a data transfer from the second radio network node to the first radio network node.

14. The method according to claim 12, wherein the method comprises:
receiving, from the second radio network node, a release request message requesting the core network node to release a UE context for the wireless device, wherein the release request message comprises an indication that the second radio network node has DL data to be transmitted to the wireless device, and
refraining from instructing the second radio network node to release the UE context for the wireless device.

15. The method according to claim 14, wherein refraining is performed for a predetermined time period or until receiving a request for retrieval of a UE context for the WD.

16. The method according to claim 15, wherein the time period is an ongoing paging time window for the wireless device.

17. The method according to claim 12, wherein the temporary identifier assigned to the WD is one or more of a radio access network temporary identifier assigned to the WD in the RNA and a core network temporary identifier.

18. The method according to claim 17, wherein the radio access network temporary identifier assigned to the WD in the RNA is an Inactive Radio Network Temporary Identifier (I-RNTI).

19. The method according to claim 17, wherein the core network temporary identifier is a 5G-S-Temporary Mobile Subscriber Identity (5G-S-TMSI).

20. (canceled)

21. A method performed by a second radio network node, for handling mobility of a wireless device (WD), wherein the wireless device is connected to a core network (CN) node and wherein the second radio network node serves a radio access network notification area (RNA) associated with the wireless device, the method comprising:
upon failing to page the WD in the RNA, sending, to the core network node, a release request message requesting the core network node to release a UE context for the wireless device, wherein the release request message comprises an indication that the first radio network node has DL data to be transmitted to the wireless device.

22-24. (canceled)
